(19) United States
(12) Patent Application Publication
(10) Pub. No.: US 2026/0276367 A1
(43) Pub. Date: Sep. 17, 2026

(54) Method of Characterizing Layer Thickness

(71) Applicant: 3M INNOVATIVE PROPERTIES COMPANY, St. Paul, MN (US)

(72) Inventors: David L. Hofeldt, Oakdale, MN (US); Jeffrey K. Eliason, Woodbury, MN (US)

(21) Appl. No.: 19/168,405

(22) PCT Filed: Mar. 25, 2024
(86) PCT No.: PCT/IB2024/052855

§ 371 Date: Sep. 24, 2025

Related U.S. Application Data
(60) Provisional application No. 63/494,805, filed on Apr. 7, 2023.

(51) Int. Cl. G01B 11/06; G01B 15/02

(52) U.S. Cl. CPC G01B 11/0625; G01B 15/02

(57) ABSTRACT

A method of characterizing thickness of at least one layer of a material includes irradiating the material with a THz pulse such that at least a portion of the THz pulse is reflected from the material as a reflected THz signal; acquiring a time-domain waveform of the reflected THz signal; fitting the time-domain waveform to a superposition of waveforms to determine pluralities of amplitudes and time shifts where each waveform in the superposition of waveforms is a reference waveform scaled by an amplitude in the plurality of amplitudes and time shifted by a time shift in the plurality of time shifts; and determining a proportional thickness of at least one layer of the material from a corresponding difference between two time shifts in the plurality of time shifts.

### TECHNICAL FIELD

The present description relates generally to methods of characterizing layer thickness using a terahertz pulse.

### BACKGROUND

A terahertz measurement system can be used to measure various properties of a sample.

### SUMMARY

In some aspects, the present description provides a method of characterizing thickness of at least one layer of a material. The method includes irradiating the material with a THz pulse such that at least a portion of the THz pulse is reflected from the material as a reflected THz signal; acquiring a time-domain waveform of the reflected THz signal; fitting the time-domain waveform to a superposition of waveforms to determine pluralities of amplitudes and time shifts, where each waveform in the superposition of waveforms is a reference waveform scaled by an amplitude in the plurality of amplitudes and time shifted by a time shift in the plurality of time shifts; and determining a proportional thickness of at least one layer of the material from a corresponding difference between two time shifts in the plurality of time shifts.

In some aspects, the present description provides a method of characterizing one or more layers of a material. The method includes irradiating the material with a THz pulse such that at least a portion of the THz pulse is reflected from the material as a reflected THz signal; acquiring a first time-domain waveform of the reflected THz signal; and using a neural network to map the first time-domain waveform to a second time-domain waveform defined by a superposition of a plurality of peaked time-domain interface waveforms, where each peaked time-domain interface waveform has a peak corresponding to a reflection from an interface of the material.

In some aspects, the present description provides a method of training a neural network. The method includes training the neural network on a computing device using training data to determine parameters of the neural network. The training data includes input data and output data. The input data includes time-domain waveform data corresponding to at least partial reflection of a THz pulse from each test sample of a first plurality of test samples. The output data includes a time-domain output waveform for each test sample of the first plurality of test samples. Each time-domain output waveform is defined by a superposition of a plurality of peaked time-domain interface waveforms. Each peaked time-domain interface waveform has a peak corresponding to a reflection from an interface of the test sample.

In some aspects, the present description provides a method of generating training data for a neural network. The training data includes input data and output data. The method includes determining the input data as time-domain waveform data corresponding to a first plurality of test samples via computer simulation of at least partial reflection of a THz pulse from each test sample of the first plurality of test samples; and for each test sample in the first plurality of test samples, determining a time-domain output waveform as a superposition of a plurality of peaked time-domain interface waveforms. Each peaked time-domain interface waveform has a peak corresponding to a reflection from an interface of the test sample. The output data includes the time-domain output waveform.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of a system for characterizing at least one layer of a material, according to some embodiments.

FIG. 2 schematically illustrates a method of characterizing thickness of at least one layer of a material, according to some embodiments.

FIG. 3 is a schematic cross-sectional view illustrating determining a reference waveform from reflection of a THz pulse from a reference surface, according to some embodiments.

FIGS. 4A-4C illustrate exemplary reference waveforms determined from reference surfaces at various positions relative to a radiation source and/or detector, according to some embodiments.

FIG. 5 illustrates exemplary acquired and fit time-domain waveforms.

FIGS. 6-8 are schematic cross-sectional views of various materials, according to some embodiments, that may be characterized according to any of the methods of the present description.

FIGS. 9A-9C are schematic cross-sectional views of materials including a structured surface having varying degrees of filling that may be characterized according to any of the methods of the present description, according to some embodiments.

FIG. 10 is an exemplary plot of proportional thicknesses along a down-web direction in a lane of a film.

FIG. 11 is a schematic illustration of a method of characterizing one or more layers of a material using a neural network, according to some embodiments.

FIGS. 12A-12B are schematic plots of superpositions of peaked time-domain interface waveforms, according to some embodiments.

FIG. 13 illustrates a time-domain waveform determined via computer simulation of a three-layer material, according to some embodiments.

FIG. 14 illustrates a time-domain waveform mapped via a neural network from a simulated time-domain waveform, according to some embodiments.

FIG. 15 illustrates a measured time-domain waveform acquired by reflecting a THz signal from a three-layer material, according to some embodiments.

FIG. 16 illustrates a time-domain waveform mapped via a neural network from a measured time-domain waveform, according to some embodiments.

FIG. 17 is a representation of an array of first time-domain waveforms determined by computer simulation of a three-layer material, according to some embodiments.

FIG. 18 is a representation of an array of second time-domain waveforms corresponding to the array of first time-domain waveforms of FIG. 17, according to some embodiments.

FIG. 19 is a schematic illustration of a method of generating training data for a neural network and a method of training a neural network, according to some embodiments.

FIG. 20 schematically illustrates an exemplary computing device that may be utilized in various methods, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some embodiments of the present description, at least one layer of a material is characterized by a proportional thickness of the layer. Here, proportional thickness refers to a property that is linearly proportional to the thickness but is not necessarily equal to the thickness. For example, according to some embodiments, a propagation time of a terahertz (THz) signal across a layer is used as a proportional thickness of the layer. If the index of refraction, which is generally a function of frequency, were known, the actual thickness could be determined by transforming from the time domain to a frequency domain and scaling the THz signal in the frequency domain by the index of refraction. However, according to some embodiments, the method of characterizing thickness is carried out entirely in the time domain and does not require knowledge of the indices of refraction of the layers of the material. This allows the proportional thickness to be determined with less information (indices of refraction), according to some embodiments, than needed in conventional methods that determine physical thickness. The proportional thickness is useful in manufacturing process, for example, since the proportional thickness can be used to monitor relative changes (e.g., percent changes) in layer thickness in the manufacturing process. Actual thickness of the layer(s) can also optionally be determined by dividing the propagation time of the terahertz (THz) signal across the layer(s) by an effective refractive index of the material of the layer(s) appropriate for the THz frequency range that was used.

According to some embodiments of the present description, at least one layer of a material is characterized by mapping a THz signal reflected from the material into a time-domain waveform that is more easily analyzed for thickness or proportional thickness than the waveform of the original THz signal reflected from the material. For example, the mapped time-domain waveform can include peaks corresponding to times of flight of a signal reflected from an interface of the material so that a spacing between the peaks of the mapped time-domain waveform can be identified as a proportional thickness of a layer. The original waveform can include the information needed to determine the thickness or proportional thickness, but it can be difficult to identify the thickness or proportional thickness directly from the original waveform. It has been found that a neural net can be trained to determine the mapped time-domain waveform from the original waveform. The training data used to train the neural net can be determined via computer simulation, for example. Models of the indices of refraction of the various layers can be included in the computer simulation and the method can include determining layer thickness and/or positions of interfaces in the material.

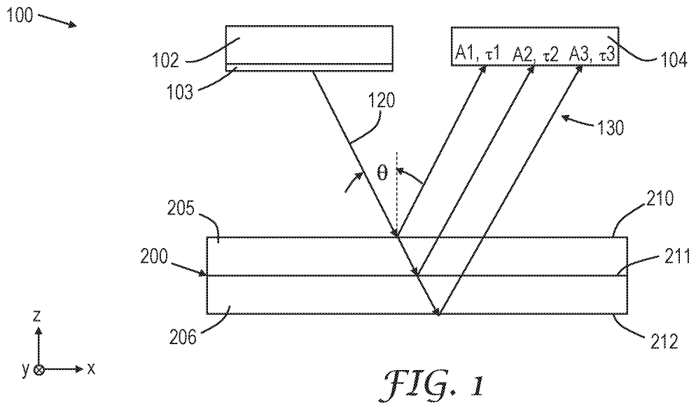

FIG. 1 is a schematic cross-sectional view of a system 100 for characterizing at least one layer of a material 200, according to some embodiments. The system 100 includes a radiation source 102 for generating a terahertz (THz) pulse 120 and a detector 104 for acquiring a time-domain waveform of the reflected THz signal 130. The THz pulse 120 can include frequencies primarily in a range of about 0.01 THz to about 25 THz, or about 0.05 THz to about 5 THz, or about 0.1 THz to about 2.5 THz, for example. THz measurement systems are known in the art and are described in U.S. Pat. No. 9,304,046 (Van Mechelen et al.); U.S. Pat. No. 10,215,696 (Zimdars et al.); U.S. Pat. No. 11,143,590 (Hofeldt), for example. In the illustrated embodiment, the material 200 includes first and second layers 205 and 206 and has interfaces 210, 211, 212. Interfaces 211 is an interface between the first and second layers 205 and 206, and interfaces 210 and 212 are interfaces of the material 200 with adjacent material(s). The reflected THz signal 130 is schematically depicted as composed of reflections from each of the interfaces where amplitudes and times of flight of the signals reflected from the interfaces are schematically indicated as A1, A2, A3 and τ1, τ2, τ3, respectively. The figure is schematically drawn for an incident beam angle of θ to simplify visualizing the separate reflections, but it will be understood that the measurement can be done with θ=0 or with non-zero values of θ.

In various embodiments, the material 200 can include one or more layers, at least two layers, or at least 3 layers, for example. The material 200 may include up to about 10, 8, or 6 layers, for example, that may be characterizing using the methods described herein. In some embodiments, one or more of the layers of the material 200 is structured. In some embodiments, the material 200 can be or include one or more of a coating, a multilayer structure, and a structured layer, for example. The material 200 can be a multilayer film, for example.

According to some embodiments, as described further elsewhere herein, the reflected THz signal 130 acquired by the detector 104 can be parameterized as a superposition of waveforms where each waveform in the superposition of waveforms is a given reference waveform scaled by an amplitude associated with a reflection from an interface (e.g., to match one of the amplitudes A1, A2, A3) and shifted in time by a time shift associated with the time travelled to and from that interface (e.g., to match one of the times of flight τ1, τ2, τ3). It has been found that a proportional thickness of a layer can be identified as a difference in the time shifts (e.g., corresponding to τ2−τ1 or τ3−τ2) associated with the layer's interfaces.

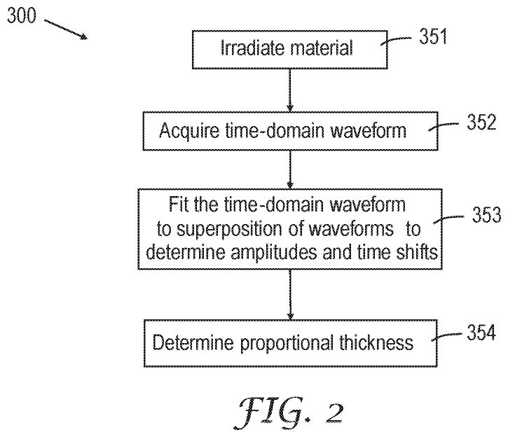

FIG. 2 schematically illustrates a method 300 of characterizing thickness of at least one layer of a material 200, according to some embodiments. The method 300 includes irradiating (step 351) the material 200 with a THz pulse 120 such that at least a portion of the THz pulse 120 is reflected from the material as a reflected THz signal 130; acquiring (step 352) a time-domain waveform of the reflected THz signal 130; fitting (step 353) the time-domain waveform to a superposition of waveforms to determine pluralities of amplitudes and time shifts; and determining (step 354) a proportional thickness of at least one layer of the material from a corresponding difference between two time shifts in the plurality of time shifts. In some embodiments, determining the proportional thickness of at least one layer of the material comprises determining proportional thicknesses of a plurality of layers of the material. Each waveform in the superposition of waveforms can be a reference waveform scaled by an amplitude in the plurality of amplitudes and time shifted by a time shift in the plurality of time shifts.

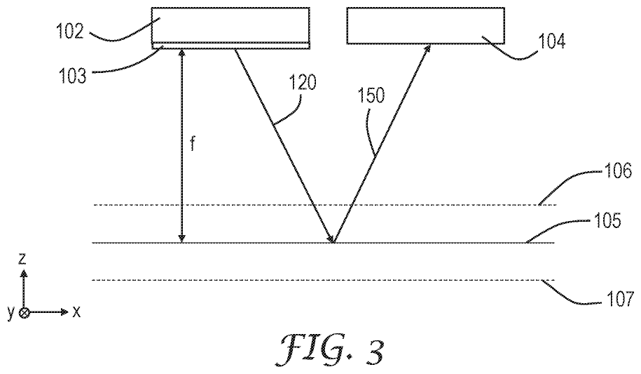

FIG. 3 is a schematic cross-sectional view of a system for determining a reference waveform (signal 150) from reflection of the THz pulse 120 from a reference surface 105, which can be a flat metal surface that generates a single reflection from it's top surface (closest to source 102), according to some embodiments. Other possible reference surface positions 106 and 107 are also schematically illustrated (e.g., corresponding to different positions of a top surface of a metal layer). In some embodiments, the THz pulse is generated using a radiation source 102 disposed at a substantially same first distance from the material when the THz pulse is reflected from the material 200 as from the reference surface (e.g., 105) when the THz pulse is reflected from the reference surface. The substantially same first distance can be a distance from the radiation source 102 to a center along a thickness direction (z-direction referring to the illustrated x-y-z coordinate system) of the material 200 within a tolerance given by a total thickness of the material 200, for example. In some embodiments, the radiation source 102 includes beam optics 103 defining a focal distance f and the first distance is about equal to the focal distance f. In some embodiments, the THz pulse is generated using a radiation source 102 disposed at a different distance from the material when the THz pulse is reflected from the material than from the reference surface when the THz pulse is reflected from the reference surface.

For testing a thick material, it can be useful to use reference surfaces of different reference materials and thicknesses, for example, so that the shapes of the waveforms acquired from reflection at a depth in the (test) material and from reflection from the upper surface of the reference material, for example, are properly recorded. In some embodiments, a plurality of waveforms from a corresponding plurality of reference surfaces is acquired and for each waveform of the superposition of waveforms, the reference waveform is selected from the plurality of waveforms according to a time that a portion of the THz pulse reflected from the material is received by a detector. For example, the portion of the THz pulse can be a portion reflected from a depth along the thickness direction corresponding to one of the reference surfaces.

The reference surface can be any suitable surface for generating a reflection. In some embodiments, the reference surface is a metal surface. In some embodiments, the reference surface 105 is a surface of a transparent or semitransparent layer that is sufficiently thick that reflections from the top or bottom side of the layer can be identified. A semitransparent layer can be useful when there is optical absorption or extinction (e.g., due to scattering, absorption, or a combination thereof) in the material 200, for example, which can change the shape of the reflected THz signal due to a frequency dependence of the optical absorption or extinction. The semitransparent layer may be used to provide a similar optical absorption or extinction as corresponding layer(s) of the material 200 above an interface of the material 200 in order to provide similar shapes to the reflected signal from the reference surface and from the interface.

As an alternative to determining a reference waveform from reflection of a THz pulse from a reference surface, the reference waveform may be determined from optical modeling of a reflection of a modeled THz pulse from a modeled reference surface (or modeled reference material), for example. In some embodiments, a plurality of waveforms from a corresponding plurality of reference surfaces (or reference materials) is determined by optical modeling. The plurality of waveforms can be utilized as described elsewhere herein.

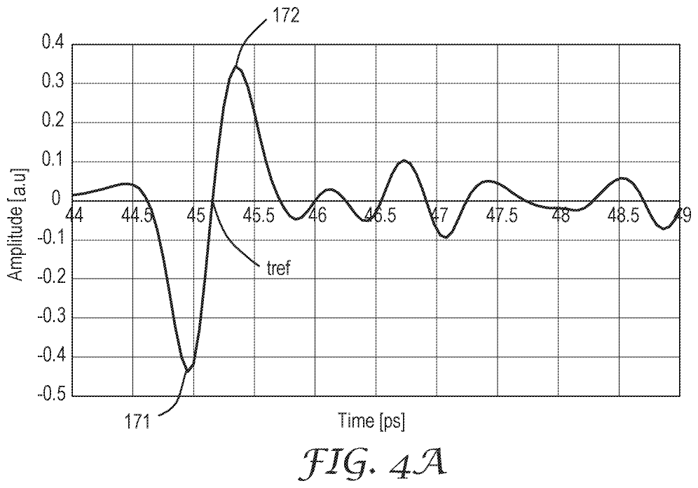

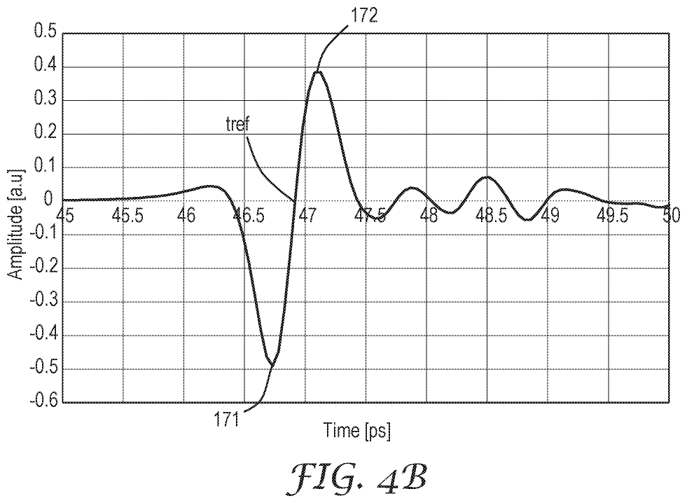

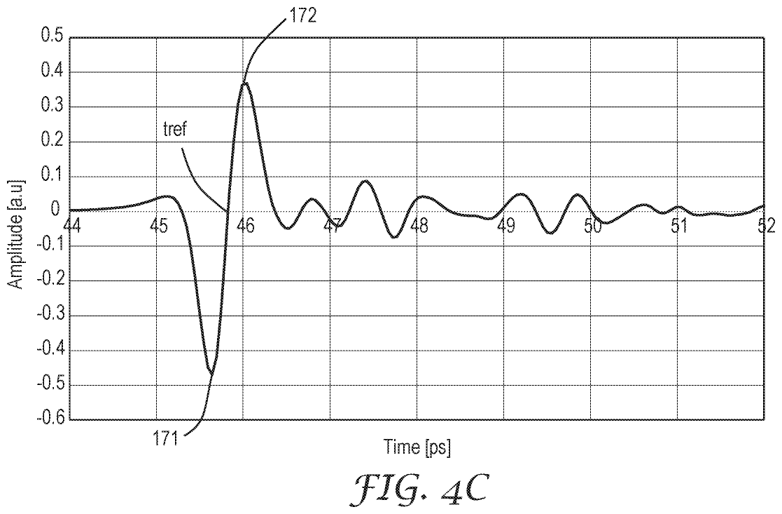

FIGS. 4A-4C illustrate exemplary reference waveforms determined from reference surfaces at various positions relative to the radiation source 102 and/or detector 104, according to some embodiments. The reference waveforms can be characterized by a reference time parameter tref given by the time that the amplitude of the reference waveform crosses zero between the first two significant peaks 171 and 172 of the reference waveform having opposite signs. The first two significant peaks 171 and 172 may be the peaks having the largest magnitude amplitudes. There may be smaller peaks at smaller times due to noise, for example, in the system that would not be considered to be significant peaks. The tref parameter for the different waveforms can be different due to the difference in positions of the corresponding reference surfaces. In some embodiments, the reference waveforms of the superposition of waveforms are derived from a plurality of waveforms determined from reflection of the THz pulse from a corresponding plurality of reference surfaces (e.g., 105, 106, 107). In some embodiments, each reference waveform is a same waveform determined from reflection of the THz pulse from a reference surface (e.g., 105). In some embodiments, the waveforms of the superposition of waveforms correspond to portions of the THz pulse reflected from a plurality of different depths along a thickness direction (e.g., z-direction of FIG. 1) of the material, and for each waveform of the superposition of waveforms, the reference waveform is selected from the plurality of waveforms according to a time that a portion of the THz pulse reflected from a corresponding depth along the thickness direction is received by a detector.

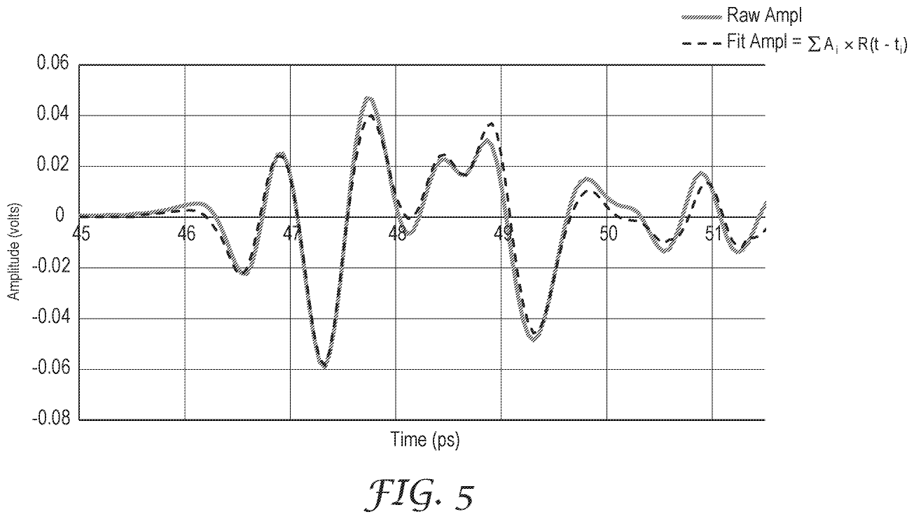

FIG. 5 illustrates exemplary acquired and fit time-domain waveforms. The fit waveform may be written as ΣAᵢ Rᵢ((t−tᵢ); trefᵢ) where the integer i labels the reflection, Rᵢ(t; trefᵢ) is a reference waveform associated with the ith reflection, trefᵢ is the reference time parameter characterizing the ith reference waveform, and Aᵢ and tᵢ are an amplitude and time shift, respectively, associated with the ith reflection. A single reference waveform, which may simply be denoted R(t), was used in the illustrated example so that the fit waveform can be written as ΣAᵢ R(t−tᵢ). When the fit includes multiple reflections from an interface, the time shifts associated with the reflections can be constrained so that there is a single independent time delay (e.g., |tᵢ₋₁−tᵢ|) associated with each pair of adjacent interfaces or depths. This time delay may be denoted as δⱼ where j is a label for the pairs of interfaces or depths. When a same reference waveform is used for adjacent interfaces or depths of a layer, the proportional thickness of the layer can be identified as δⱼ. In the case where different reference waveforms are used for the adjacent interfaces or depths, the proportional thickness of the layer can be identified as δⱼ shifted by a difference between the reference time parameters trefᵢ of the reference waveforms to account for a shift in time between the different reference waveforms (e.g., the reference waveforms may be determined from reference surfaces at different positions resulting in different times of flight between the radiation source 102 and the detector 104).

The number of reflections (i.e., the number of terms in the sum over scaled and time-shifted reference waveforms) considered in the fit can be selected based on the structure of the material being characterized. For example, different reflections from different portions of a structured surface can be included. As another example, multiple reflections from an interface (e.g., internal reflections in the material) can be included. For example, radiation can be partially reflected and partially transmitted at a first interface, the partially transmitted portion can be partially reflected at a different second interface, the partially reflected light from the second interface can be again incident on the first interface where it can be again partially reflected and partially transmitted. Each partial reflection can be included in the fit. The series of partial reflections can be truncated to neglect amplitudes for successive reflections that are sufficiently small. In some embodiments, only the first reflection from an interface or each portion of a structured interface is included in the fit. In some embodiments, the number of reflections included in the fit is in a range of 2 to 100, 3 to 50, or 4 to 30, for example.

The fit can be determined using a portion of the reference waveform that can be selected based on the locations of the strongest peaks and the propagation time needed to capture the main features in the reflected signal. Generally, it can be desired to limit the time range (and therefore the number of points) used in the fit since the more points that are used, the longer the fitting takes. The time window/number of points used may be determined by two things: 1) the length of time in the reflected signal that is needed to fit to get good results for reflections from all interfaces included in the fit, which may include multiple reflections from interfaces, and 2) the amplitude of the decaying oscillations of the reference signal (those following the main peaks) relative the amplitudes of the reflections included in the fit. For example, the fit can be determined over a continuous range of times (e.g., at least about 3 or 4 ps wide and less than about 30, 15, or 10 ps wide) which can be substantially less than a full range of times available (e.g., 100 ps or more) when any peaks in the range not included in the fit has amplitudes substantially less than amplitudes in the range included in the fit. The fit can be determined as a least squares fit, or another regression method known in the art can be used, to determine the parameters Aᵢ, δⱼ and a time of a first reflection from the material. Useful regression algorithms are defined in commercially available software such as MATLAB (MathWorks, Inc., Natick, MA) and Mathematica (Wolfram Research, Inc., Champaign, IL), for example.

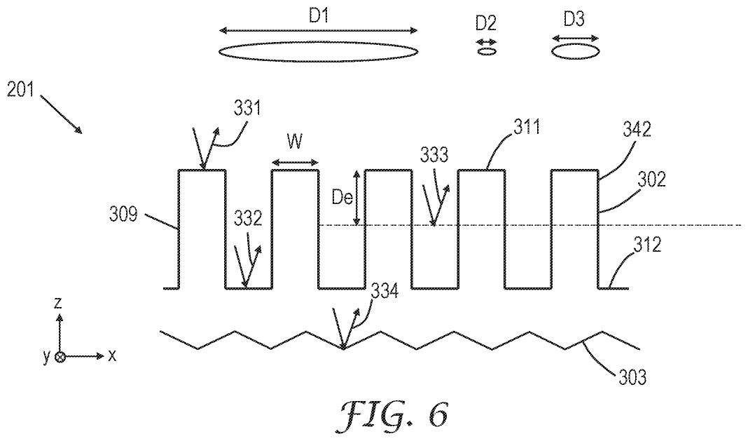

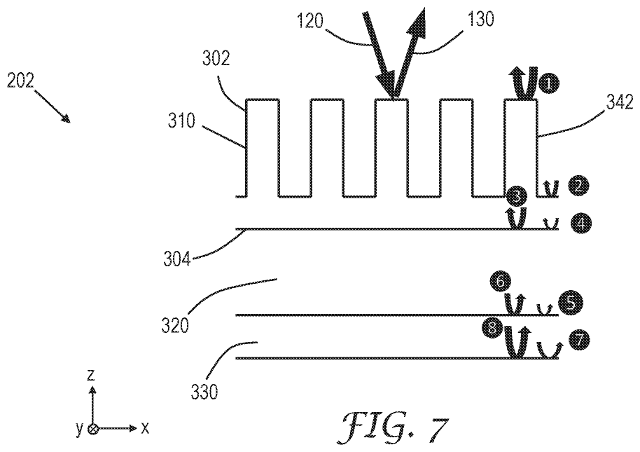

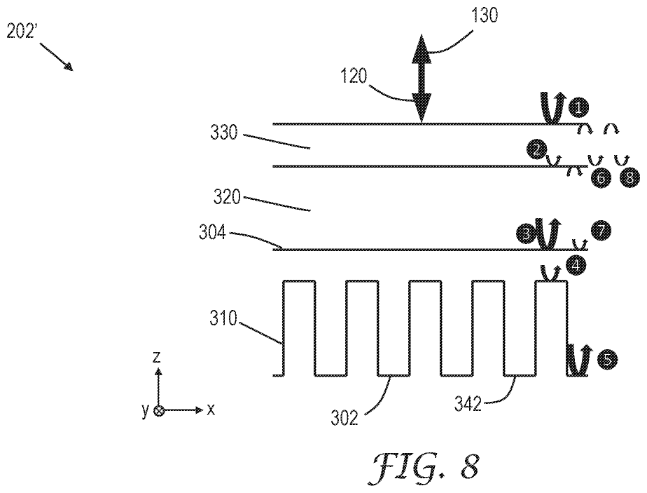

FIGS. 6-8 are schematic cross-sectional views of various materials (201, 202, 202′) that may be characterized according to any of the methods of the present description, according to some embodiments. Related materials are described in U.S. Pat. Appl. Pub. Nos. 2010/0271721 (Gaides et al.); 2019/0346615 (Johnson et al.); and 2022/0019007 (Schmidt et al.), for example, and in Int. Pat. Appl. No. WO 2021/090207 (Liu et al.), for example. In FIG. 6, the material 201 includes a layer 309 having opposing first and second structured major surfaces 302 and 303. In FIGS. 7-8, the material 202, 202′ includes layers 310, 320, and 330. Layer 310 can correspond to layer 309 except that the second major surface 304 of layer 310 is not structured. Material 202 and 202′ can be the same material rotated 180 degrees about the y-axis. A structured surface can include a plurality of engineered structures such as engineered microstructures. Engineered microstructures can have dimensions in each of at least two orthogonal directions in a range of 10 nm to 1 mm, or 100 nm to 500 microns, for example. An unstructured surface is generally free of engineered structures but may have surface roughness due to ordinary manufacturing conditions, for example. A substantially planar surface is an unstructured surface extending generally in a plane.

In some embodiments, a method for characterizing thickness of at least one layer of a material is provided. In some embodiments, the at least one layer includes a first layer 309, 310 having a structured first major surface 302 and an opposite second major surface 303, 304. In some embodiments, the first major surface 302 includes first and second portions 311 and 312 spaced apart in a thickness direction (z-direction) of the material, where the second portion 312 disposed between the first portion 311 and the second major surface 303 or 304.

In some embodiments, portions 331, 332 of the THz pulse are reflected from each of the first and second portions 311 and 312. Distinct portions 331 and 332 are typically identifiable when the surface features are large enough (e.g., large compared to an average wavelength of the THz pulse) to generate distinct reflections at the top and bottom of the structures. In some embodiments, instead of distinct reflected portions 331 and 332, a portion 333 of the THz pulse is reflected from an effective depth De between the first and second portions 311 and 312. This can occur when surface features are small enough (e.g., small compared to an average wavelength of the THz pulse so that the structures can be described by an effective refractive index) to generate a reflection from the major surface 302 without generating distinct reflections at the top and bottom of the structures. Portions 331, 332 and 333 are each schematically illustrated in FIG. 6, but it will be understood that often either portions 331 and 332 are reflected, or portion 333 is reflected, but not both. In some embodiments, the plurality of time shifts comprises time shifts of portions 331 and 332 of the THz pulse reflected from the first and second portions. In some embodiments, the plurality of times shifts comprises a time shift of a portion 333 of the THz pulse reflected from an effective depth De between the first and second portions 311 and 312 of the structured first major surface. In some embodiments, the pluralities of amplitudes and time shifts include at least one amplitude and at least one time shift associated with the first major surface 302. The at least one amplitude and the at least one time shift can be a single amplitude and a single time shift from an effective depth De. In some embodiments, the pluralities of amplitudes and time shifts include at least two amplitudes and at least two time shifts associated with the first major surface. In some embodiments, the method includes amplitude and time-shift parameters for each of portions 331, 332 and 333 and the fitting to the reflected THz signal determines the relative amplitudes of these portions (e.g., the feature sizes may be near the middle of the range of THz wavelengths so that the features are small compared to longer wavelengths, and large compared to smaller wavelengths of the THz pulse.).

In some embodiments, the second major surface 303 is structured (e.g., as schematically shown in FIG. 6). In some embodiments, the second major surface 303 is substantially planar (e.g., as schematically shown in FIGS. 7-8 for surface 304). In some embodiments, the plurality of time shifts further comprises a time shift of a portion 334 of the THz pulse reflected from the second major surface 303. The portion 334 may reflect in a different direction than schematically illustrated in FIG. 6 due to the structures of the surface 303. In some embodiments, the method includes amplitude and time-shift parameters for portions of 334 reflected from tops, bottoms, and/or an effective depth of structures of the second major surface 303.

FIG. 6 schematically illustrates various possible spot sizes of the THz pulse. In some embodiments, the structured first major surface 302 includes a plurality of structures having an average width W along a width direction (x-direction) orthogonal to a thickness direction (z-direction) of the material. In some embodiments, the THz pulse has a spot size D1 greater than the average width W. In some embodiments, the THz pulse has a spot size D2 smaller than the average width W. In some embodiments, the THz pulse has a spot size D3 about equal to the average width W. The spot size of the THz pulse relative to the width of the features that it strikes can determine the number of reflections that will contribute to the reflected signal at any instant.

In some embodiments, the structured first major surface includes a plurality of structures 342 extending along a first direction (y-direction, length direction) orthogonal to a thickness direction (z-direction) of the material and arranged along a second direction (x-direction, width direction) orthogonal to each of the first and thickness directions. In some embodiments, the THz pulse is incident on the material in an incident plane including the thickness direction and one of the first and second directions. In some embodiments, the THz pulse is incident on the material in an incident plane (x-z plane) including the first direction and the thickness direction (see, e.g., FIGS. 6 and 7). In some embodiments, the THz pulse is incident on the material in an incident plane (y-z plane) including the second direction and the thickness direction (see, e.g., FIG. 8).

In some embodiments, the THz pulse 120 is incident on the material along a direction making an angle θ (see, e.g., FIG. 1) with a thickness direction (z-direction) of the material. The angle θ can be less than about 45, 40, 35, 30, 25, 20, 15, or 10 degrees, for example. The angle θ can be selected based on an angle relative to a surface structure, for example, or can be selected to be close to normal to a plane of the material, for example. In some embodiments, the THz pulse is substantially normally incident (e.g., corresponding to θ being less than about 20, 15, or 10 degrees, or corresponding to θ being 0 degrees) on the material.

In some embodiments, the THz pulse 120 can be at least partially (e.g., fully or partially) polarized, or substantially unpolarized, and/or can have an orientation of polarization. For example, the THz pulse 120 can be polarized primarily along either the y-axis or the x-axis, or the THz pulse can have substantially equal components polarized along the x-axis and polarized along the y-axis. An at least partially polarized THz pulse can have a degree of polarization (e.g., as quantified by Stokes parameters) of greater than 30, 40, 50, 60, 70, 80, or 90 percent, for example. A substantially unpolarized THz pulse can have a degree of polarization of less than 30, 20, or 10 percent, for example.

In FIGS. 7-8 reflections are schematically illustrated from 5 different depths. The plurality of time shifts can include a time shift for each of the 5 depths. Eight different partial reflections are schematically illustrated in each of these figures. The plurality of amplitudes can include an amplitude for each of the 8 reflections. FIGS. 7-8 can correspond to the same material oriented differently. The incident plane may be the y-z plane or the x-z plane, for example, regardless of the orientation of the material 202, 202′.

In FIG. 7, reflection 1 is at an interface between the top portion 311 (see, e.g., FIG. 6) and air, reflection 2 is between the bottom portion 312 (see, e.g., FIG. 6) and air, reflections 3 and 4 are at the interface between second major surface 304 and layer 320 of light transmitted (reflection 3) or not transmitted (reflection 4) through a structure 342, reflections 5 and 6 are at an interface between layers 320 and 330 of light transmitted (reflection 6) or not transmitted (reflection 5) through a structure 342, and reflections 7 and 8 are at an interface between layer 330 and an adjacent layer (e.g., a support layer under the material 202) of light transmitted (reflection 8) or not transmitted (reflection 7) through a structure 342.

In FIG. 8, reflection 1 is at an interface between layer 330 and air, reflection 2 is at an interface between layers 330 and 320, reflections 3 and 7 are at an interface between layers 320 and 310 of light having transmitted portions incident on (reflection 7) or not on (reflection 3) a structure 342, reflection 4 is between a bottom portion 312 (see, e.g., FIG. 6) and air, reflection 5 is between top portion 311 (see, e.g., FIG. 6) and an adjacent layer (e.g., a support layer under the material 202′).

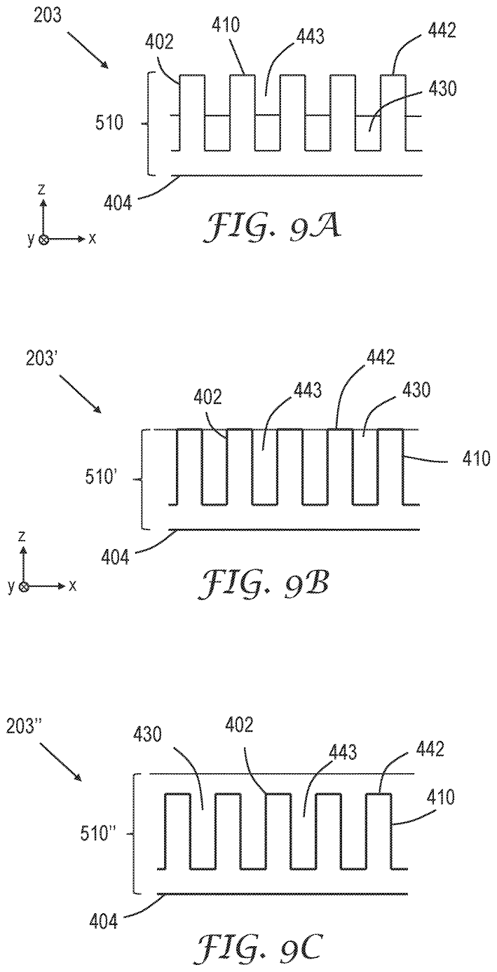

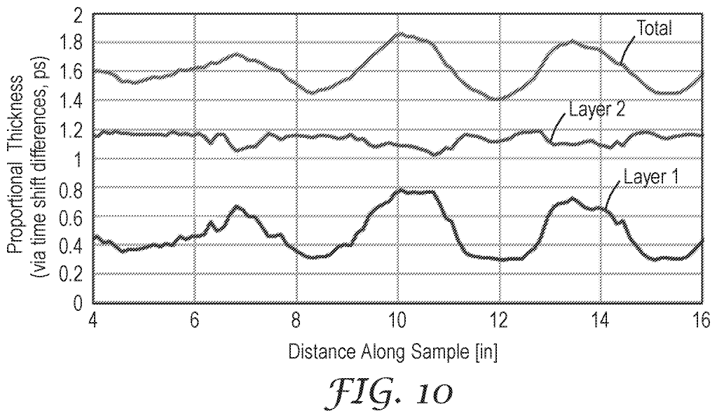

FIGS. 9A-9C are schematic cross-sectional views of materials 203, 203′, 203″ that can be characterized according to the methods described herein, according to some embodiments. In some embodiments, the material 203, 203′, 203″ includes a layer 410 (e.g., corresponding to layer 310) having a structured first major surface 402 and an opposite second major surface 404. The material 203, 203′, 203″ can optionally further include one or more additional layers as described elsewhere herein. The structured first major surface 420 includes a plurality of structures 442 defining a plurality of gaps 443 therebetween where the gaps 433 can be at least partially filled with another material 430. It will be understood that at least partially filled with another material means at least partially filled with a material other than air. This material can be a solid material such as a polymeric material, for example. The layer 410 with the at least partially filled gaps 433 defines a composite layer 510, 510′, 510″. The gaps 443 are, in some embodiments, under-filled (see, e.g., FIG. 9A), substantially completely filled (see, e.g., FIG. 9B), or over-filled (see, e.g., FIG. 9C). Reflections can occur at any of the interfaces between material 430 and air (or another layer at a top surface, if present) and between the material 430 and the material of layer 410. In the case of material 203′, reflections can occur at a top surface of composite layer 520′ which includes contributions from reflections from top surfaces of the structures 442 and top surfaces of the material 430. Other reflections can occur as described further elsewhere herein. The second major surface 404 can optionally also be structured (e.g., as shown for surface 303 in FIG. 6), in which case the second major surface 404 can optionally similarly be at least partially filled with another material. In some embodiments, the material 430 is optically absorptive (e.g., so that material 203′ is a light control film or a privacy film).

In some embodiments, successive reflected waveforms are acquired for a structured material; the amplitude information in the waveforms are converted into a gray scale value; and then the resulting gray scale waveforms are stacked next to each other to build an image (with each subsequent waveform adding another row or column to the image). Such images may be referred to as a B-scan image (see, e.g., FIG. 17).

In some embodiments, a method of the present description (e.g., a waveform fitting method using scaled and time-shifted reference waveforms, or a waveform mapping method using a neural net) of characterizing one or more layers of a material includes determining a proportional thickness of one or more layers of the material at a plurality of different positions along a length and/or width of the material. For example, proportional thicknesses can be determined at different positions along a down-web or cross-web direction of a film during making of the film or after the film has been made. The method can be used to monitor a film manufacturing process (e.g., for real-time quality control) and/or to determine which process conditions can be adjusted to minimize down-web and cross-web variations in the thickness profiles.

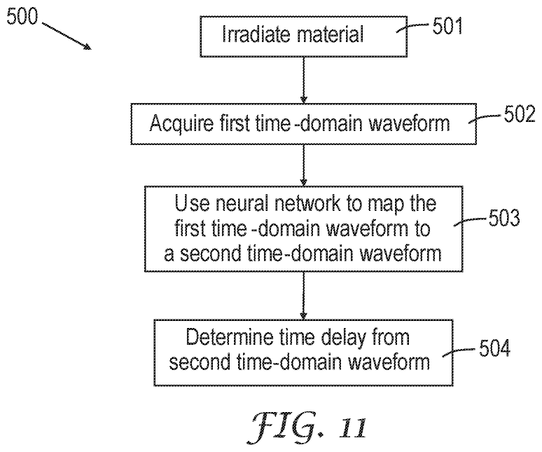

FIG. 10 is an exemplary plot of proportional thicknesses along a down-web direction in a lane of a film made using a blown film process that produced a hollow cylinder of film, often referred to as the “bubble” in the blown film art, that was slit into lanes. Proportional thicknesses are shown for first and second layers (Layers 1 and 2) and for the combination (Total) of the layers. In the illustrated example, the proportional thicknesses were determined using a waveform fitting method of the present description that utilized scaled and time-shifted reference waveforms.

As an alternative to fitting the reflected THz waveform, machine learning may be used to map the reflected THz waveform to a waveform that can be more readily analyzed to determine proportional or actual thicknesses, for example, as described further elsewhere herein. For example, a small, wide peak in the original waveform that may be difficult to distinguish from adjacent peaks can be mapped to a taller, narrower peak that is easier to distinguish from adjacent mapped peaks.

The machine learning can be deep learning and/or can utilize a neural network. As is known in the art, neural networks generally include a network of nodes (or neurons) arranged in node layers including an input layer, one or more hidden layers, and an output layer. Neural networks can be trained by providing data to the neural network so that the trained neural network can predict an output based on new input data. Neural networks are described in “Artificial Neural Networks: A Tutorial”, Jain et al., Computer 29.3 (1996): 31-44; “Introduction to Convolutional Neural Networks”, J. Wu, National Key Lab for Novel Software Technology, Nanjing University, China, 5.23 (2017): 495; “U-Net: Convolutional Networks for Biomedical Image Segmentation”, Ronneberger et al., arXiv: 1505.04597v1 (2015); and U.S. Pat. No. 10,923,141 (Jansson et al.) and U.S. Pat. No. 11,508,037 (Yang et al.), for example. Useful types of neural networks include convolutional neural networks, for example. Useful convolutional neural networks include U-Net neural networks, for example. A convolutional neural network generally includes at least one hidden layer that performs convolutions (e.g., a layer that performs a dot product of a convolution kernel with the layer's input matrix). A U-Net is a convolutional neural network that includes a contracting path and an expansive path which gives it a U-shaped architecture (see, e.g., FIG. 1 of Ronneberger et al.; FIG. 5 of U.S. Pat. No. 10,923,141 (Jansson et al.); and FIG. 5 of U.S. Pat. No. 11,508,037 (Yang et al.)). The contracting path is typically a convolutional network that can include repeated application of convolutions, which can each be followed by a rectified linear unit (ReLU) and a max pooling operation. During the contraction, the spatial and/or temporal information is typically reduced while feature information is typically increased. The expansive path typically combines features and information through a sequence of up-convolutions and concatenations with high-resolution features from the contracting path.

In some embodiments, the neural network is or includes a convolutional neural network which may be a 1-dimensional convolutional neural network or a higher dimensional convolutional neural network (e.g., a 2-dimensional convolutional neural network). In some embodiments, the neural network is or includes a U-Net neural network which may be a 1-dimensional U-Net neural network or a higher dimensional U-Net neural network (e.g., a 2-dimensional U-Net neural network). A 1-dimensional U-Net (or a 1D convolutional neural net) is useful for analyzing individual THz signals where the dimension is time. A 2-dimensional U-Net (or a 2D convolutional neural net) is useful for analyzing a plurality of stacked THz signals. For example, the stacked THz signals can be determined from scanning different positions (e.g., B-scans) where the dimensions are time and the scan dimension. A 3-dimensional U-Net (or a 3D convolutional neural net) is useful for analyzing a plurality of stacked signals determine from scanning 2-dimensionally along a surface of a sample, for example.

Useful software for implementing neural networks include Mathematica (Wolfram Research, Inc., Champaign, IL), MATLAB+Deep Learning Toolbox (Math Works, Inc., Natick, MA), TensorFlow (open source software available at https://www.tensorflow.org), and KERAS (open source software available at https://keras.io). KERAS is a deep learning Application Programming Interface (API) written in Python and running on top of the machine learning platform TensorFlow. Suitable layer APIs defined in KERAS for performing convolutions include Conv1D and Conv1DTranspose (which are useful for 1-dimensional U-Net neural networks), Conv2D and Conv2DTranspose (which are useful for 2-dimensional U-Net neural networks), and Conv3D and Conv3DTranspose (which are useful for 3-dimensional U-Net neural networks). Suitable layer APIs defined in KERAS for activation (e.g., ReLU activation) include Activation. Suitable layer APIs defined in KERAS for concatenation include Concatenate. Suitable layer APIs defined in KERAS for performing max pooling include MaxPooling 1D, MaxPooling2D, or MaxPooling3D. Other useful layer APIs defined in KERAS include GlobalAveragePooling 1D, GlobalAveragePooling2D, GlobalAveragePooling3D, InputLayer, BatchNormalization, Dropout, Flatten, and Dense, for example.

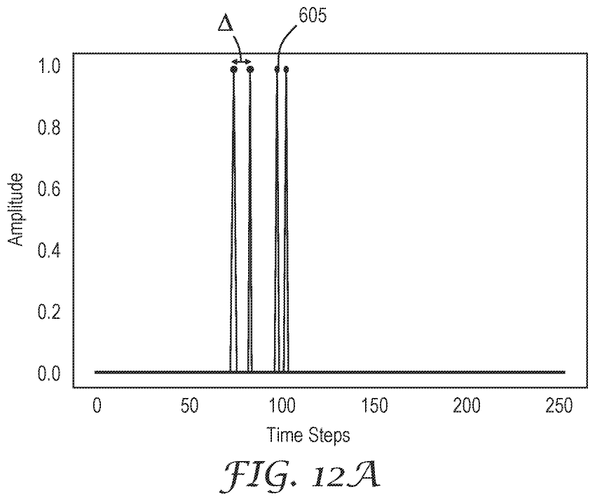

FIG. 11 is a schematic illustration of a method 500 of characterizing one or more layers of a material using a neural network, according to some embodiments. In some embodiments, a method 500 of characterizing one or more layers of a material includes irradiating (step 501) the material with a THz pulse such that at least a portion of the THz pulse is reflected from the material as a reflected THz signal; acquiring (step 502) a first time-domain waveform of the reflected THz signal; and using a neural network (step 503) to map the first time-domain waveform to a second time-domain waveform defined by a superposition of a plurality of peaked time-domain interface waveforms, where each peaked time-domain interface waveform includes a peak corresponding to a reflection from an interface of the material. The neural network schematically represented by step 503 in FIG. 11 can be a convolutional neural network such as a U-Net neural network, for example.

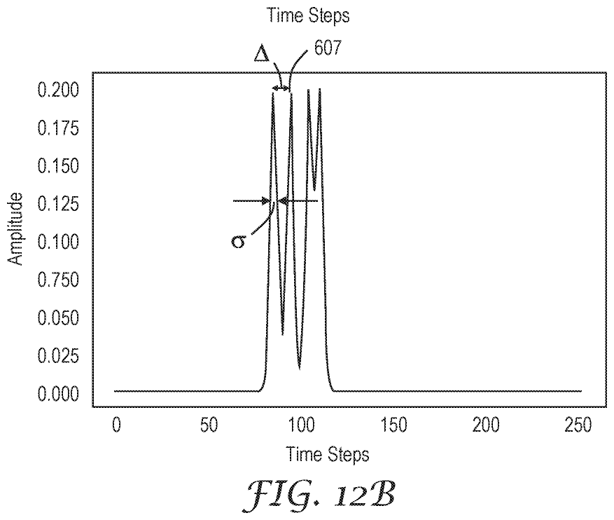

FIGS. 12A-12B are schematic plots of superpositions of peaked time-domain interface waveforms, according to some embodiments. The abscissa is time determined as a number of time steps where each time step corresponds to a measurement interval (e.g., about 0.1 ps) of a detector. In FIG. 12A, the peaked time-domain interface waveforms 605 are Kronecker delta functions. In FIG. 12B, the peaked time-domain interface waveforms 607 each have a standard deviation σ greater than zero. The peaked time-domain interface waveforms 607 can be Gaussians, polynomials, Lorentzian functions, or Voigt functions, for example. The peaked time-domain waveforms can have a same peak amplitude or can have different peaked amplitudes. It has been found that using peak amplitudes that are about the same can make it easier to identifying peaks corresponding to interfaces between layers having close refractive indices compared to using peak amplitudes corresponding to amplitudes in the original acquired waveform, for example.

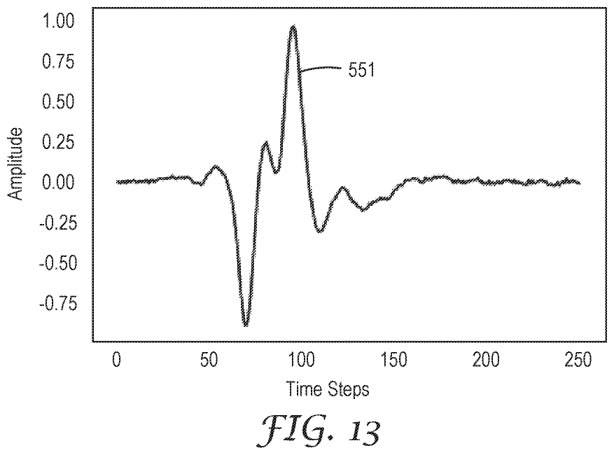

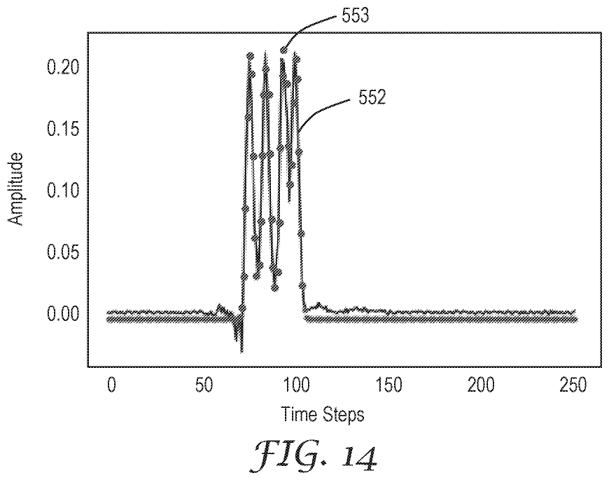

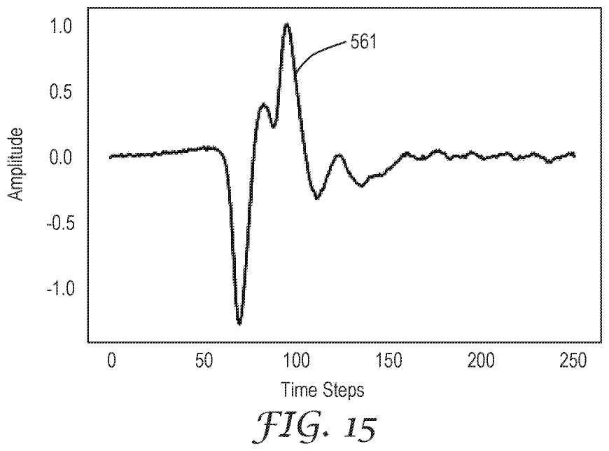

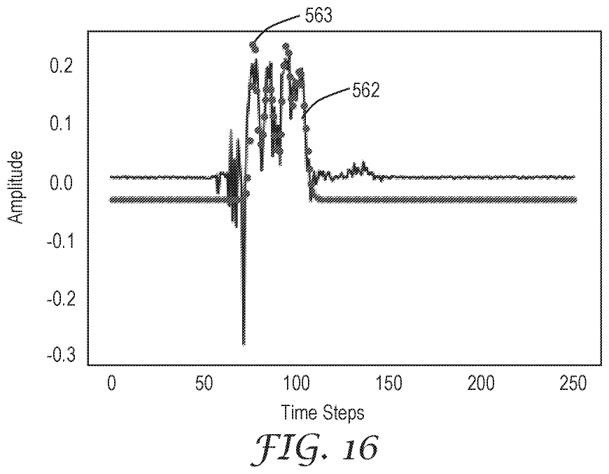

FIG. 13 illustrates a (first) time-domain waveform 551 determined via computer simulation of a three-layer material, according to some embodiments. FIG. 14 illustrates a (second) time-domain waveform 552 determined from the time-domain waveform 551 using a neural network as a superposition of peaked time-domain interface waveforms 607, according to some embodiments. FIG. 15 illustrates a (first) time-domain waveform 561 acquired by reflecting a THz pulse from a three-layer material, according to some embodiments. FIG. 16 illustrates a (second) time-domain waveform 562 determined from the time-domain waveform 561 using a neural network as a superposition of peaked time-domain interface waveforms 607, according to some embodiments.

In some embodiments, the method 500 further includes determining (step 504 indicated in FIG. 11) one or more time delays as a corresponding one or more spacings A between adjacent peaks of the plurality of peaked time-domain interface waveforms 605, 607. In some embodiments, the one or more spacings A are identified, or the spacing(s) can be scaled so that the scaled spacing(s) are identified, as a corresponding one or more proportional thicknesses of a corresponding one or more layers of the material. In some embodiments, the method 500 further includes determining one or more proportional thicknesses of one or more layers of the material from a corresponding one or more spacings A between adjacent peaks of the plurality of peaked time-domain interface waveforms. For the waveform fitting methods described elsewhere herein, according to some embodiments, proportional thickness(es) are determined in the time-domain without determining physical thickness(es). In some embodiments of the neural network-based waveform mapping methods described herein, proportional thickness(es) are determined without determining physical thickness(es). In other embodiments of the waveform mapping methods described herein, physical thickness(es) are determined. In some embodiments, physical thickness(es) can be determined from the neural network since the neural network is trained with modeled data where the model used for training the neural network can also allow physical thickness (or spacing between adjacent interfaces) to be determined from the mapped (second) waveform.

In some embodiments, the method 500 further includes determining relative positions of a plurality of interfaces of the material from the peaks of the plurality of peaked time-domain interface waveforms. A relative position of an interface of the plurality of interfaces can be a position of the interface relative to an adjacent interface or relative to a same interface (e.g., a top or bottom interface) in the plurality of interfaces. The relative positions can be expressed as physical distances or as proportional distances. For example, the relative positions can be expressed as differences between locations of corresponding peaks of the plurality of peaked time-domain interface waveforms from the first peak of the plurality of peaked time-domain interface waveforms and these differences can be interpreted as proportional distances of the interfaces from a first (e.g., top) interface.

In some embodiments, the method 500 is configured to determine a total number of layers of the material. The neural network can be trained with samples (e.g., computer simulated samples) having different numbers of layers so that the number of peaked time-domain interface waveforms included in the second (mapped) time-domain waveform can be determined by the neural network. The total number of layers of the material can then be determined from the number of peaks of the second time-domain waveform.

In some embodiments, a detector 104 measures the time-domain waveform of the reflected THz signal 130 at a plurality of discrete times td (e.g., corresponding to the time steps of FIG. 12A). In some embodiments, each peaked time-domain interface waveform comprises a Kronecker delta function δ(td,tId) where tId is a time in the plurality of discrete times that is closest to a time that a signal reflected from an interface of the material is incident on the detector. A peaked time-domain interface waveform that comprises a Kronecker delta function δ(td,tId) can have the form c1×δ(td,tId)+c2, where c1 is a non-zero proportionality constant and c2 is an offset constant. In some embodiments, c1 is 1 and c2 is 0.

In some embodiments, a detector 104 measures the time-domain waveform of the reflected THz signal 130. In some embodiments, each peaked time-domain interface waveform 607 comprises a time-domain peaked function having a predetermined functional form and centered on a time that a signal reflected from an interface of the material is incident on the detector. In some embodiments, each time-domain peaked function is a Gaussian. In some embodiments, each time-domain peaked function is selected from the group consisting of Gaussians, polynomials, Lorentzian functions, and Voigt functions.

In some embodiments, each peaked time-domain interface waveform 607 comprises a time-domain Gaussian (or other function having a predetermined functional form) centered on a time that a signal reflected from an interface of the material is incident on the detector. In some embodiments, the detector 104 measures the time-domain waveform of the reflected THz signal at a plurality of discrete times arranged at an interval ΔT. In some embodiments, for at least one interface in the plurality of interfaces, the Gaussian (or other function having a predetermined functional form) has a standard deviation σ greater than 0.2 times the interval ΔT. In some embodiments, for at least one interface in the plurality of interfaces, the Gaussian (or other function having a predetermined functional form) has a standard deviation σ in a range of 0.25 to 4 times ΔT, or 0.5 to 2 times ΔT, or 0.75 to 1.25 times ΔT, or σ can be about ΔT. In some embodiments, for each interface in the plurality of interfaces, the Gaussian (or other function having a predetermined functional form) has a standard deviation σ in a range of 0.25 to 4 times ΔT, or 0.5 to 2 times ΔT, or 0.75 to 1.25 times ΔT, or σ can be about ΔT. The detector 104 can have a resolution ΔT in a range of about 0.02 ps to about 0.5 ps, for example. ΔT can be about 0.1 ps, for example.

An advantage of using Kronecker delta functions for the interface waveforms is that different interfaces can be well separated in the time domain for layer thickness larger than ΔT/(2n) where n is a refractive index of the layer. However, for thinner layers, the peaks in the delta function corresponding to opposite sides of the layer can be located at the same time td since the same td may be the closest td to the time of reflection from each of the interfaces. To distinguish such peaks, a Gaussian or other peaked function with a σ greater than 0 or greater than 0.2 times the interval ΔT, for example, may be preferred. Such peaked functions can allow interfaces closer together than ΔT/(2n) to be distinguished since the centers and/or peaks of the functions can be located at the precise time of reflection from each of the interfaces even when those times do not precisely coincide with a time td. However, if σ is too large, it can be difficult to distinguish the different Gaussians (or other peaked functions) for the adjacent interfaces. Accordingly, a σ less than 5 times the interval ΔT may be preferred. It has been found that a standard deviation σ in a range of 0.25 to 4 times ΔT, for example, provides a desired resolution of adjacent interfaces.

In some embodiments, the center of the Gaussian, or center or peak of another predetermined peaked function, does not coincide with any of the discrete times td sampled by the detector 104. The neural network can determine the second (mapped) time-domain waveform at the times td which may not include the precise center or peak of the Gaussian or other predetermined function. In this case, it may be desired to fit the second time-domain waveform determined by the neural net to peaked functions having predetermined functional forms (e.g., Gaussians) and determining the locations of the peaks of the second time-domain waveform from locations (e.g., centers) of these peaked functions.

In some embodiments, the method includes determining locations of the peaks of the plurality of peaked time-domain interface waveforms from the second time-domain waveform by fitting peaks of the second time-domain waveform to peaked functions having predetermined functional forms (e.g., dots 553 in FIG. 14 or dots 563 in FIG. 16 can represent peaked functions, such as Gaussians, fit to peaks of the respective waveform 552 or 562) and determining the locations of the peaks of the plurality of peaked time-domain interface waveforms from parameters of the peaked functions. For example, the parameters of a Gaussian can be taken to be a mean and a standard deviation, and the mean can be identified as the location of the peak. The predetermined functional forms can be those of Gaussians, polynomials, Lorentzian functions, and Voigt functions, for example. In some embodiments, the peaked functions are Gaussians and the locations of the peaks of the plurality of peaked time-domain interface waveforms are determined as centers of the Gaussians. In some embodiments, the peaked functions are polynomials and the locations of the peaks of the plurality of peaked time-domain interface waveforms are determined as location of peaks of the polynomials. In some embodiments, the method includes determining locations of the peaks of the plurality of peaked time-domain interface waveforms from the second time-domain waveform by fitting peaks of the second time-domain waveform to Gaussians and identifying the locations of the peaks of the plurality of peaked time-domain interface waveforms as locations of corresponding centers of the Gaussians.

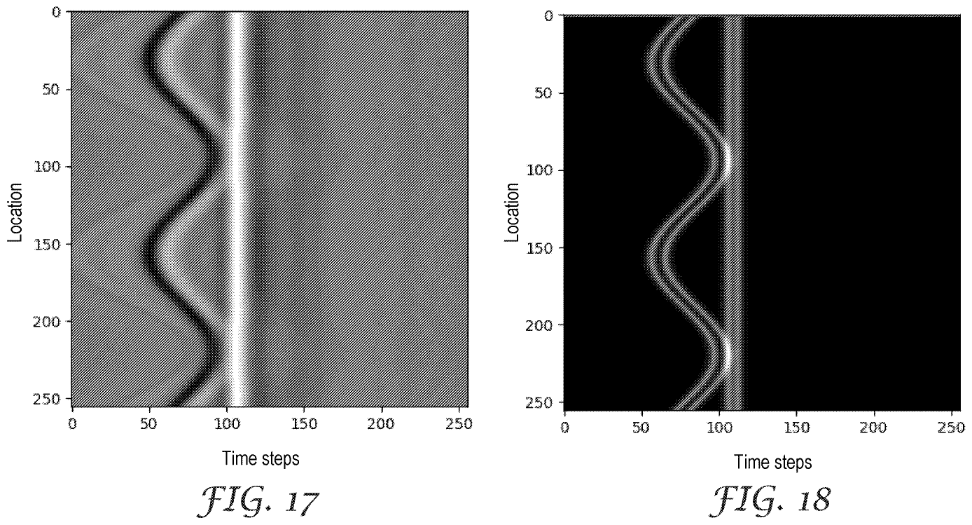

In some embodiments, irradiating the material with a THz pulse (step 501 of FIG. 11) includes irradiating the material at a plurality of locations. Acquiring a first time-domain waveform (step 502) can then include acquiring a first time-domain waveform for each location of the plurality of locations. The method 500 can include forming an array of the first time-domain waveforms. In some embodiments, the amplitude information in the array of the first time-domain waveforms are converted to gray scale values to define an image (B-scan image). FIG. 17 is an image formed in this way from a reflected THz signal determined via modeling a three-layer material where the first and last layers were kept at a constant thickness and the middle layer thickness was varied with location following a sine wave. For each point along the ordinate, the gray scale values along the abscissa provide amplitude versus time step data corresponding to one of the first time-domain waveforms in the array of first time-domain waveforms. In some embodiments, using the neural net to map the first time-domain waveform to the second time-domain waveform (step 503) comprises using the neural net (e.g., a two-dimensional U-Net) to map the array of the first time-domain waveforms to an array of second time-domain waveforms. The amplitude information in the array of second time-domain waveforms can also be converted to grayscale values to define an image. FIG. 18 is an image formed in this way from an array of second time-domain waveforms corresponding the array of first time-domain waveforms of FIG. 17. For each point along the ordinate of FIG. 18, the gray scale values along the abscissa provide amplitude versus time step data corresponding to one of the second time-domain waveforms in the array of second time-domain waveforms. Each of second time-domain waveform of the array of second time-domain waveforms can be defined by a superposition of a plurality of peaked time-domain interface waveforms where each peaked time-domain interface waveform incudes a peak corresponding to a reflection from an interface of the material.

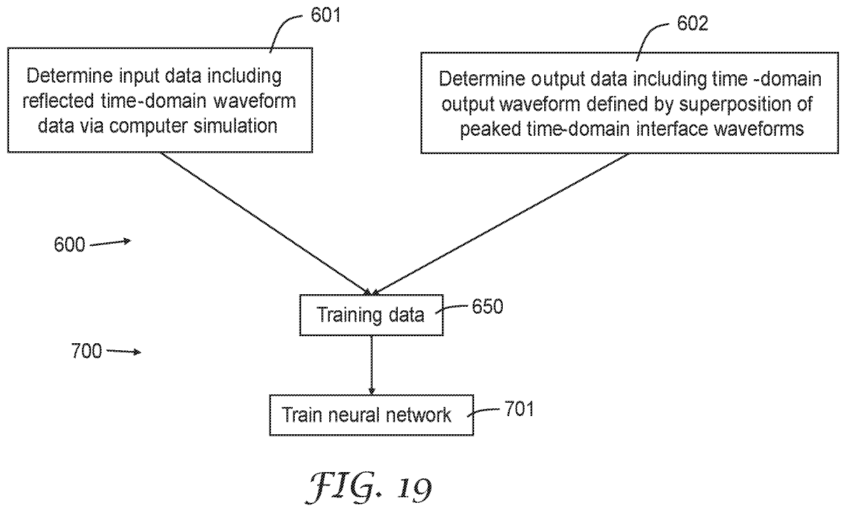

FIG. 19 is a schematic illustration of a method 600 of generating training data for a neural network and a method 700 of training a neural network, according to some embodiments.

In some embodiments, a method 600 of generating training data 650 for a neural network is provided. The training data includes input data (e.g., as generated in step 601) and output data (e.g., as generated in step 602). The method 600 includes determining the input data (step 601) as time-domain waveform data corresponding to a first plurality of test samples via computer simulation of at least partial reflection of a THz pulse from each test sample of the first plurality of test samples; and for each test sample in the first plurality of test samples, determining a time-domain output waveform (step 602) as a superposition of a plurality of peaked time-domain interface waveforms. Each peaked time-domain interface waveform can include a peak corresponding to a reflection from an interface of the test sample. The output data includes the time-domain output waveform. The computer simulation of the at least partial reflection of the THz pulse can be carried out, for example, using standard optical modeling techniques. For example, the waveform of the THz pulse can be Fourier transformed into a frequency-domain waveform; each layer of the material can be modeled as having a frequency dependent refractive index which is often known for known materials or can be determined using a time-domain or frequency domain terahertz spectroscopy system, for example; the refractive index can be used in the Fresnel equations to determine reflection and transmission at each interface of the modeled sample which can be combined using a transfer-matric approach, for example, to determine a frequency-domain waveform of the at least partially reflected THz pulse; and the frequency-domain waveform can then be Fourier transformed to produce the time-domain waveform of the at least partially reflected THz pulse.

In some embodiments, the method 600 includes, for each peaked time-domain interface waveform, determining a location of the peak of the peaked time-domain interface waveform via the computer simulation of the at least partial reflection of the THz pulse. For example, the time-domain output waveform can be determined by determining the time of flights of the reflections from the various interfaces from the computer simulation and using these times to determine the appropriate locations of the peaks in the peaked time-domain interface waveforms so that the peaked time-domain interface waveforms can then be superimposed to determine the time-domain output waveform.

In some embodiments, the time-domain waveform data includes, for each test sample of the first plurality of test samples, a waveform amplitude for each time in a plurality of discrete times td corresponding to detection times of a detector, where the waveform amplitude is determined from the computer simulation of the at least partial reflection of the THz pulse. The time-domain interface waveforms can have any suitable functional form. In some embodiments, for each test sample of the first plurality of test samples, each peaked time-domain interface waveform comprises a Kronecker delta function δ(td,tId), where tId is a time in the plurality of discrete times td that is closest to a time that a portion of the THz pulse reflected from an interface of the test sample is incident on the detector. In some embodiments, for each test sample of the first plurality of test samples, each peaked time-domain interface waveform comprises a time-domain Gaussian (or other function having a predetermined functional form described elsewhere) centered on a time that a portion of the THz pulse reflected from an interface of the test sample is incident on the detector. In some embodiments, for each test sample of the first plurality of test samples, the discrete times td are arranged at an interval ΔT and the Gaussian has a standard deviation in a range of 0.25 to 4 times ΔT or in another range described elsewhere herein.

In some embodiments, a method 700 of training a neural network includes training the neural network (step 701) on a computing device using training data 650 to determine parameters of the neural network. The training data 650 includes input data and output data. The training data 650 can be determined as described elsewhere herein. The input data includes time-domain waveform data corresponding to at least partial reflection of a THz pulse from each test sample of a first plurality of test samples. The output data includes a time-domain output waveform for each test sample of the first plurality of test samples. Each time-domain output waveform is defined by a superposition of a plurality of peaked time-domain interface waveforms. Each peaked time-domain interface waveform can have a peak corresponding to a reflection from an interface of the test sample. The method 700 of training the neural network using the training data can include determining the parameters of the neural network using any suitable technique known in the art. The parameters of the neural network typically include weights of connections between neurons of the neural network and biases of the neurons of the neural network. Suitable training techniques can include using a gradient descent algorithm such as an Adam optimizer as described in “Adam: A Method for Stochastic Optimization”, Kingma et al., arXiv:1412.6980v9 (2017), for example.

In some embodiments, each time-domain interface waveform is given at a plurality of discrete times td arranged at an interval ΔT. Each peaked time-domain interface waveform can comprise a peak corresponding to a reflection from an interface of the test sample. The time-domain interface waveforms used for training the neural network can have any suitable functional form described elsewhere herein. For example, in some embodiments, each peaked time-domain interface waveform comprises a Gaussian centered at the peak corresponding to the reflection from the interface and having a standard deviation in a range of 0.25 to 4 times ΔT or in another range described elsewhere herein. As another example, in some embodiments, each peaked time-domain interface waveform comprises a Kronecker delta function δ(td,tId), where tId is a time in the plurality of discrete times td that is closest to a time of the peak corresponding to the reflection from the interface.

In some embodiments, the neural network is further trained with time-domain waveform data acquired by partially reflecting a THz pulse from each test sample of a second plurality of test samples. Where the second plurality of test samples are physical test samples. The time-domain output waveforms for the physical test samples can be obtained using the time of flights of the reflections from the various interfaces of the physical test sample that can be determined from modeling the physical test sample using the same or similar computer simulation used in determining times of flights for the first plurality of test samples.

At least portions of various methods of the present description (e.g., using a neural network, training a neural network, generating training data, determining input data and/or output data for training a neural network, or fitting a time-domain waveform to a superposition of waveforms) can be implemented in digital electronic circuitry, in tangibly embodied computer software or firmware, in computer hardware, or in combinations of one or more of them, and/or can be implemented as one or more computer programs.

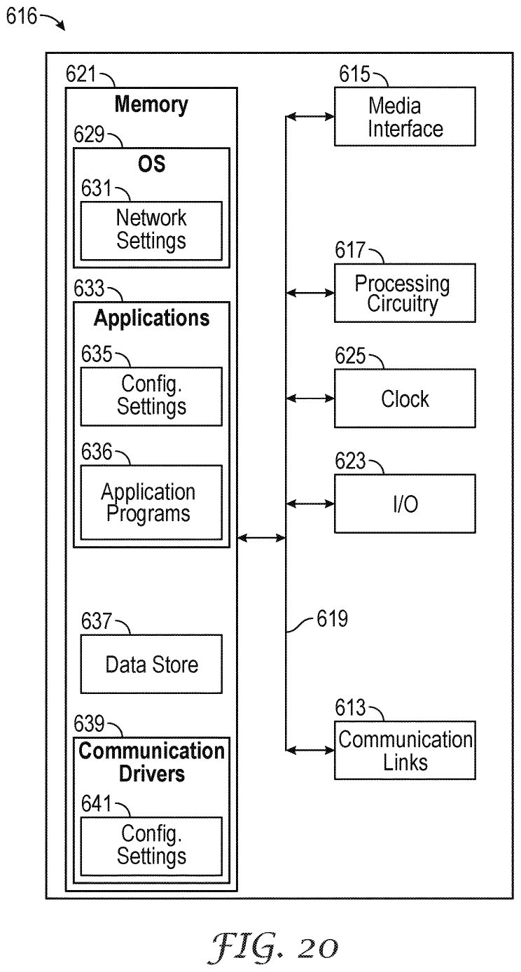

FIG. 20 schematically illustrates an example computing device 616 that may be configured to perform one or more of the techniques described herein. FIG. 20 provides a general block diagram of the components of a computing device 616 that can run some algorithms and/or process steps (e.g., any one or more of steps 353, 354, 503, 504, 601, 602, 701) described herein. In the computing device 616, a communications link 613 is optionally provided that allows the device to communicate with other computing devices. Communications link 613 may incorporate network interface hardware, such as one or more wired and/or wireless network interface controllers (NICs). In some embodiments, applications can be received on removable computer readable media (e.g., flash drive or Secure Digital (SD) card) that is connected to a media interface 615. Interface 615 and communication link 613 communicate with processing circuitry 617 along a bus 619 that is also connected to memory 621 and input/output (I/O) components 623, as well as clock 625. I/O components 623, in some embodiments, are provided to facilitate input and output operations and the computing device 616 can include input components such as keyboard, buttons, touch sensors, optical sensors, microphones, and/or touch screens, and output components such as a display device, a speaker, and/or a printer port. Other I/O components 623 can be used as well. Clock 625 illustratively comprises a real time clock component that outputs a time and date. It can also provide timing functions for processing circuitry 617. Memory 621 stores operating system 629, network settings 631, applications 633, application configuration settings 635, application programs 636, data store 637, communication drivers 639, and communication configuration settings 641.

In some embodiments, memory 621 and processing circuitry 617 may be integrated into a single hardware unit, such as a system on a chip (SoC) or integrated circuit (IC). The processing circuitry 617 may include one or more of a multi-core processor, a controller, a digital signal processor (DSP), an application specific integrated circuit (ASIC), a field-programmable gate array (FPGA), processing circuitry (e.g., fixed function circuitry, programmable circuitry, or any combination of fixed function circuitry and programmable circuitry) or equivalent discrete logic circuitry or integrated logic circuitry.

Memory 621 may include any form of memory for storing data and executable software instructions, Memory 621 can include all types of tangible volatile and non-volatile computer-readable memory devices. It can also include computer storage media such as internal hard disks or removable disks, magneto optical disks, and CD ROM and DVD-ROM disks. Memory 621 may include random-access memory (RAM), read-only memory (ROM), programmable read only memory (PROM), erasable programmable read-only memory (EPROM), electronically erasable programmable read only memory (EEPROM), and flash memory. Memory 621 can store computer readable instructions that, when executed by processing circuitry 617, cause the processing circuitry 617 to perform computer-implemented steps or functions according to the instructions. Processing circuitry 617 may be activated by other components to facilitate their functionality as well.

At least portions of various methods of the present description can include determining quantities (e.g., training data or parameters of a neural network) on processing circuitry 617 and outputting the quantities from processing circuitry 617 to computer readable media (e.g., corresponding to data store 637, the removable computer readable media connected to the media interface 615, and/or the computer storage media described elsewhere herein).

In some embodiments, a method 500 of characterizing one or more layers of a material includes irradiating the material with a THz pulse (e.g., step 501; see, e.g., FIG. 11) from a radiation source 102 (see, e.g., FIG. 1) such that at least a portion of the THz pulse is reflected from the material as a reflected THz signal; acquiring, with a detector 104, a first time-domain waveform of the reflected THz signal (e.g., step 502); and using a neural network on a computing device 616 to map the first time-domain waveform to a second time-domain waveform defined by a superposition of a plurality of peaked time-domain interface waveforms (e.g., step 503) where each peaked time-domain interface waveform comprising a peak corresponding to a reflection from an interface of the material.

In some embodiments, a method 700 of training a neural network includes training the neural network on a computing device 616 using training data 650 to determine parameters of the neural network. The input data includes time-domain waveform data corresponding to at least partial reflection of a THz pulse from each test sample of a first plurality of test samples. Output data includes a time-domain output waveform for each test sample of the first plurality of test samples, where each time-domain output waveform is defined by a superposition of a plurality of peaked time-domain interface waveforms and each peaked time-domain interface waveform includes a peak corresponding to a reflection from an interface of the test sample. The input and output data can be stored in memory 621 and the processing circuitry 617 can determine the parameters of the neural network which can then be stored in memory 621. The method 700 can include outputting the parameters of the neural network via an interface 615 of the computing device 616.

In some embodiments, a method 600 of generating training data 650 for a neural network is provided. The training data 650 includes input data and output data. The method includes determining the input data as time-domain waveform data corresponding to a first plurality of test samples via computer simulation performed by a computing device 616 of at least partial reflection of a THz pulse from each test sample of the first plurality of test samples; and for each test sample in the first plurality of test samples, determining via the computing device 616 a time-domain output waveform as a superposition of a plurality of peaked time-domain interface waveforms where each peaked time-domain interface waveform includes a peak corresponding to a reflection from an interface of the test sample. The output data includes the time-domain output waveforms. The method can include outputting the training data 650 via an interface 615 of the computing device 616.

In some embodiments, a method of characterizing thickness of at least one layer of a material includes irradiating the material with a THz pulse (e.g., step 351; see, e.g., FIG. 2) from a radiation source 102 (see, e.g., FIG. 1) such that at least a portion of the THz pulse is reflected from the material as a reflected THz signal; acquiring, with a detector 104, a time-domain waveform (e.g., step 352) of the reflected THz signal; fitting the time-domain waveform to a superposition of waveforms using a computing device 616 to determine pluralities of amplitudes and time shifts (e.g., step 353), where each waveform in the superposition of waveforms is a reference waveform scaled by an amplitude in the plurality of amplitudes and time shifted by a time shift in the plurality of time shifts; and determining, using the computing device 616, a proportional thickness (e.g., step 354) of at least one layer of the material from a corresponding difference between two time shifts in the plurality of time shifts. The fitting and determining steps can be carried out by the processing circuitry 617 of the computing device 616 and the resulting proportional shifts can be stored in memory 621 and/or output via interface 615 of the computing device 616.

### EXAMPLES

### 1. Waveform Fitting Method

### A. Multilayered Louvered Material, Louvers Up, Plane of Incidence of Beam Optics Oriented Across Louvers

A fast, high bandwidth (~5 THz) TOPTICA TeraFlash system (available from TOPTICA Photonics AG, Graefelfing, Germany) was used with focused beam optics in a reflection configuration where the angle of the incident beam was 7.8° from the normal of the film plane and the detector was oriented to collect a specular reflection, also at 7.8° from the normal to the film plane. A reference waveform was determined as the system response to a reflection from a metal surface and is shown in FIG. 4A.

Samples as generally shown in FIG. 7 were analyzed. The layer 310 of the sample has at total thickness of about 115 micrometers with the structures 342 (louvers) having a height of about 90 microns and the land region having a thickness of about 25 microns. The layer 320 had an approximate thicknesses of about 76 microns. For different first and second samples, the layer 330 had a thickness of about 59 and 44 microns, respectively. The layer 330 was formed from a 4 micron thick hardcoat and a premask modeled as a single layer in the analysis. The premask in the second sample was hazy and thinner compared to the premask in the first sample. The refractive indices of layers 310, 320 and 330 were about 1.55, 1.7, and 1.5, respectively. The plane of incidence was across the louvers, as indicated in FIG. 7.

The independent parameters in the fit that were allowed to vary to achieve the best fit included the four time delays associated with the five depths and the 8 amplitudes of the assumed reflections indicated in FIG. 7, and the time of the first reflection. Only a 5 ps portion of the reference signal that include the strongest peaks was used for the fit. Estimated values for thicknesses and refractive indices were used only to establish initial guess for the time delays, and the initial amplitude guesses were established by inspection of the waveform. though the refractive indices were not needed in determining the waveform fit or the time delays. Results for the second sample are shown in FIG. 5. Results of the fit for the first and second samples are given in the following tables. The amplitudes correspond to the reflections numbered in FIG. 7 and the time delays correspond to reflection depths from the tops of the structures 342.

| | A1 | A2 | A3 | A4 | A5 | A6 | A7 | A8 |
|---|---|---|---|---|---|---|---|---|
| Sample | (volts) | (volts) | (volts) | (volts) | (volts) | (volts) | (volts) | (volts) |
| 1 | −0.0570 | −0.0259 | −0.0199 | −0.00037 | 0.0142 | 0.0064 | 0.0426 | 0.0222 |
| 2 | −0.0298 | −0.0610 | −0.0219 | −0.00030 | 0.0143 | 0.0176 | 0.0286 | 0.0461 |

| | δt1 | δt2 | δt3 | δt4 |
|---|---|---|---|---|
| Sample | (ps) | (ps) | (ps) | (ps) |
| 1 | 0.7819 | 0.2216 | 0.8619 | 0.5803 |
| 2 | 0.7247 | 0.2344 | 0.8472 | 0.3773 |

### B. Multilayered Louvered Material, Louvers Down, Plane of Incidence of Beam Optics Oriented Across Louvers

Sample 2 described above was flipped over (as shown in FIG. 8) and analyzed as described for Example 1A with the plane of incidence across the louvers (as shown in FIG. 7). Two internal reflections were allowed in the fit within layer 330 and one internal reflection within layer 320 was allowed in the fit. The fit constrained the absolute value of the amplitude of each subsequent internal reflection to be less than the absolute value of the amplitude of the reflection that preceded it. Results are provided in the following tables. The amplitudes correspond to the reflections numbered in FIG. 8 and the time delays correspond to reflection depths from the top of layer 330. The time delays associated with the layers were similar to those determined above for Sample 2 in the louvres up case. The layer 330 of FIG. 8 represented a hardcoat and a premask layer of the sample. It is believed that the resulting fit could have been improved by including in the fit additional reflections at the interface between the hardcoat and the premask layer, for example.

| A1 | A2 | A3 | A4 | A5 | A6 | A7 | A8 |
|---|---|---|---|---|---|---|---|
| (volts) | (volts) | (volts) | (volts) | (volts) | (volts) | (volts) | (volts) |
| −0.0607 | −0.0243 | 0.0032 | 0.0457 | 0.0105 | −0.0066 | 0.0018 | −0.0044 |

| δt1 | δt2 | δt3 | δt4 |
|---|---|---|---|
| (ps) | (ps) | (ps) | (ps) |
| 0.3994 | 0.8542 | 0.2453 | 0.7455 |

### C. Multilayered Louvered Material, Louvers Down, Plane of Incidence of Beam Optics Oriented Along Louvers

Sample 2 was again oriented as shown in FIG. 8 and analyzed as generally described for Example 1B but with the plane of incidence along the louvers as shown in FIG. 8. Results are provided in the following tables. The amplitudes correspond to the reflections numbered in FIG. 8 and the time delays correspond to reflection depths from the top of layer 330. The time delay predictions for the louver layer are significantly different in this orientation, indicating that the effective index of that structure is different than for the across-the-groove case. However, it is not necessary to actually calibrate any index difference in order to assess the uniformity of the louvre layer using the time delay data.

| A1 | A2 | A3 | A4 | A5 | A6 | A7 | A8 |
|---|---|---|---|---|---|---|---|
| (volts) | (volts) | (volts) | (volts) | (volts) | (volts) | (volts) | (volts) |
| −0.0788 | −0.0243 | 0.0154 | 0.0264 | 0.0386 | −0.0015 | 0.0089 | −0.0009 |

| δt1 | δt2 | δt3 | δt4 |
|---|---|---|---|
| (ps) | (ps) | (ps) | (ps) |
| 0.4466 | 0.8683 | 0.2511 | 0.7678 |

D. Structured Surfaces with Moderate-Bandwidth TERAMETRIX Time-Domain THz System

A moderate bandwidth time-domain THz system TERAMETRIX T-RAY 5000 (available from Luna Innovations, Roanoke, VA) having a bandwidth of nominally 2 THz was used in a reflection mode that utilized a beam splitter such that both the incident THz beam and the reflected signal were oriented substantially normal to the material plane (x-y plane) on the same side of the material. With a 2 THz bandwidth, the shortest wavelength in air that would contribute to the signal would be roughly 150 microns.

The TERAMETRIX system was used to collect signals from a series of optically clear adhesive (OCA) films in which the adhesive layer was sandwiched in between two PET liners that were either 2 mil or 3 mil thick. For layer thicknesses below 4 mils, the reflected pulses from the various interfaces overlapped significantly, but the fitting method was still able to recover the correct proportional thicknesses of each of the three layers. Results are provided in the following table. The estimated thicknesses of the layers were determined as k times the time delays determined from the waveform fit. The scaling factors k were determined by fitting measured thicknesses to measured time delays. The k values (for time delay in ps and thicknesses in mils) were e 3.37, 3.81, and 3.28 for the top PET layer, the middle OCA layer, and the bottom PET layer, respectively. The scaling factor k was included so that estimated thicknesses could be compared with nominal thicknesses of the layers, but the proportional thickness of the layers can be taken to be the time delays determined by the fit without determining k values.

| | Top PET Fit | Middle | Middle OCA | | Bottom PET |
|---|---|---|---|---|---|
| Top | Time Delay | OCA | Fit Time | Bottom | Fit Time |
| PET | [ps] | Nominal | Delay [ps] | PET | Delay [ps] |
| Thick- | (estimated | Thick- | (estimated | Thick- | (estimated |
| ness | thickness | ness | thickness | ness | thickness |
| (mils) | [mils]) | (mils) | [mils]) | (mils) | [mils]) |
| 3 | 0.897 (3.02) | 6.4 | 1.719 (6.54) | 3 | 0.942 (3.09) |
| 3 | 0.854 (2.88) | 6.4 | 1.689 (6.42) | 2 | 0.624 (2.05) |
| 3 | 0.892 (3.01) | 4 | 1.031 (3.93) | 2 | 0.615 (2.02) |
| 2 | 0.628 (2.11) | 2 | 0.532 (2.03) | 2 | 0.622 (2.04) |

### 2. Neural Net Waveform Mapping Method

A neural network was trained using training data generated by computer simulation of reflection of a THz pulse from a three-layer film including a 3 mil thick top PET layer, a 2 mil PET bottom layer, and an acrylate middle layer having a thickness varying from 2 mils to 25 mils in 1 micron increments. In the computer simulation, the waveform of the THz pulse was Fourier transformed into a frequency-domain waveform; each layer of the material was modeled as having a frequency dependent refractive index; Fresnel equations were used to determine reflection and transmission at each interface of the modeled sample; the reflections and transmissions at the interfaces were using a transfer-matrix approach to determine a frequency-domain waveform; and the frequency-domain waveform was Fourier transformed to produce the reflected time-domain waveform. To model various experimental conditions, time shifts from −3 ps to 3 ps in 1 ps steps were incorporated into the resulting waveforms. A total of 457 simulated waveforms were generated.

Two classes of time-domain interface waveforms were modeled: Kronecker delta functions and Gaussians. Gaussians with standard deviations σ of 0.3, 1, and 2 times ΔT (0.1 ps) were modeled. FIG. 12A shows a superposition of Kronecker delta functions and FIG. 12B shows a superposition of Gaussians with σ=2 ΔT.

The time-domain waveform reflected from each multilayer thin film and the superposition of time-domain interface waveforms were transformed into two corresponding 1×256 1D arrays as the corresponding input and output data for training the neural network. Different neural nets were trained with output data corresponding to the different types of interface waveforms.

The neural networks were 1-dimensional U-Nets implemented using KERAS APIs as indicated in the following table:

| Name | Type | Shape |
|---|---|---|
| input_10 | InputLayer | [(None, 256, 1)] |
| conv1d_90 | Conv1D | (None, 256, 64) |
| batch_normalization_108 | BatchNormalization | (None, 256, 64) |
| activation_108 | Activation | (None, 256, 64) |
| conv1d_91 | Conv1D | (None, 256, 64) |
| batch_normalization_109 | BatchNormalization | (None, 256, 64) |
| activation_109 | Activation | (None, 256, 64) |
| max_pooling1d_18 | MaxPooling1D | (None, 128, 64) |
| conv1d_92 | Conv1D | (None, 128, 128) |
| batch_normalization_110 | BatchNormalization | (None, 128, 128) |
| activation_110 | Activation | (None, 128, 128) |
| conv1d_93 | Conv1D | (None, 128, 128) |
| batch_normalization_111 | BatchNormalization | (None, 128, 128) |
| activation_111 | Activation | (None, 128, 128) |
| max_pooling1d_19 | MaxPooling1D | (None, 64, 128) |
| conv1d_94 | Conv1D | (None, 64, 256) |
| batch_normalization_112 | BatchNormalization | (None, 64, 256) |
| activation_112 | Activation | (None, 64, 256) |
| conv1d_95 | Conv1D | (None, 64, 256) |
| batch_normalization_113 | BatchNormalization | (None, 64, 256) |
| activation_113 | Activation | (None, 64, 256) |
| conv1d_transpose_18 | Conv1DTranspose | (None, 128, 128) |
| batch_normalization_114 | BatchNormalization | (None, 128, 128) |
| activation_114 | Activation | (None, 128, 128) |
| concatenate_18 | Concatenate | (None, 128, 256) |
| conv1d_96 | Conv1D | (None, 128, 128) |
| batch_normalization_115 | BatchNormalization | (None, 128, 128) |
| activation_115 | Activation | (None, 128, 128) |
| conv1d_97 | Conv1D | (None, 128, 128) |
| batch_normalization_116 | BatchNormalization | (None, 128, 128) |
| activation_116 | Activation | (None, 128, 128) |
| conv1d_transpose_19 | Conv1DTranspose | (None, 256, 64) |
| batch_normalization_117 | BatchNormalization | (None, 256, 64) |
| activation_117 | Activation | (None, 256, 64) |
| concatenate_19 | Concatenate | (None, 256, 128) |
| conv1d_98 | Conv1D | (None, 256, 64) |
| batch_normalization_118 | BatchNormalization | (None, 256, 64) |
| activation_118 | Activation | (None, 256, 64) |
| conv1d_99 | Conv1D | (None, 256, 64) |
| batch_normalization_119 | BatchNormalization | (None, 256, 64) |
| activation_119 | Activation | (None, 256, 64) |
| out | Conv1D | (None, 256, 1) |

To evaluate the performance of the multiple trained 1D-Unet models, both simulated waveform and real waveform data were tested. FIGS. 13 and 15 show the simulated waveform and measured waveform, respectively, of three-layer film with 3 mil (76.2 microns) PET top layer, 4 mil (101.6 microns) acrylate middle layer and 2 mil (50.8 microns) PET bottom layer. FIGS. 14 and 16 show the mapped time domain waveforms determined from the waveforms of FIGS. 13 and 15, respectively. The time-domain interface waveforms used in FIGS. 14 and 16 were Gaussians with a standard deviation σ of 2 ΔT. The curves 552 and 562 are the mapped time-domain interface waveforms, and the dots 553 and 563 are the fitted four Gaussian functions. The center of the four 10 Gaussian functions in the simulated data were at 77.28, 86.01, 95.90 and 102.268, which resulted in a thickness of 98.9 microns for the middle acrylate layer. The center of the four Gaussian functions in the measured data were 78.35, 86.51, 96.05 and 103.51, which resulted in a thickness of 95.3 microns for the middle acrylate layer.

Results for using delta functions and from using Gaussians having standard deviations σ of 0.3, 1, and 2 times ΔT (0.1 ps) for the time-domain interface waveforms indicated that using a Gaussian with σ equal to ΔT gave improved resolution compared to the other tested choices.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. A method of characterizing thickness of at least one layer of a material, the method comprising:
irradiating the material with a THz pulse such that at least a portion of the THz pulse is reflected from the material as a reflected THz signal;
acquiring a time-domain waveform of the reflected THz signal;
fitting the time-domain waveform to a superposition of waveforms to determine pluralities of amplitudes and time shifts, each waveform in the superposition of waveforms being a reference waveform scaled by an amplitude in the plurality of amplitudes and time shifted by a time shift in the plurality of time shifts; and
determining a proportional thickness of at least one layer of the material from a corresponding difference between two time shifts in the plurality of time shifts.

2. The method of claim 1, wherein each reference waveform is a same waveform determined from reflection of the THz pulse from a reference surface.

3. The method of claim 2, wherein the THz pulse is generated using a radiation source disposed at a substantially same first distance from the material when the THz pulse is reflected from the material as from the reference surface when the THz pulse is reflected from the reference surface.

4. The method of claim 2, wherein the THz pulse is generated using a radiation source disposed at a different distance from the material when the THz pulse is reflected from the material than from the reference surface when the THz pulse is reflected from the reference surface.

5. The method of claim 1, wherein the reference waveforms of the superposition of waveforms are derived from a plurality of waveforms determined from reflection of the THz pulse from a corresponding plurality of reference surfaces.

6. The method of claim 5, wherein the waveforms of the superposition of waveforms correspond to portions of the THz pulse reflected from a plurality of different depths along a thickness direction of the material, and wherein for each waveform of the superposition of waveforms, the reference waveform is selected from the plurality of waveforms according to a time that a portion of the THz pulse reflected from a corresponding depth along the thickness direction is received by a detector.

7. The method of claim 1, wherein the at least one layer comprises a first layer having a structured first major surface and an opposite second major surface.

8. The method of claim 7, wherein the first major surface comprises first and second portions spaced apart in a thickness direction of the material, the second portion disposed between the first portion and the second major surface.

9. The method of claim 8, wherein the plurality of time shifts comprises time shifts of portions of the THz pulse reflected from the first and second portions.

10. The method of claim 8, wherein the plurality of times shifts comprises a time shift of a portion of the THz pulse reflected from an effective depth between the first and second portions of the structured first major surface.

11. The method of claim 7, wherein the structured first major surface comprises a plurality of structures extending along a first direction orthogonal to a thickness direction of the material and arranged along a second direction orthogonal to each of the first and thickness directions.

12. The method of claim 11, wherein the THz pulse is incident on the material in an incident plane comprising the thickness direction and one of the first and second directions.

13. The method of claim 7, wherein the structured first major surface comprises a plurality of structures defining a plurality of gaps therebetween, wherein the gaps are at least partially filled with another material.

14. The method of claim 7, wherein the pluralities of amplitudes and time shifts comprise at least two amplitudes and at least two time shifts associated with the first major surface.

15. The method of claim 1, wherein determining the proportional thickness of at least one layer of the material comprises determining proportional thicknesses of a plurality of layers of the material.
